(19) United States
(12) Patent Application Publication
(10) Pub. No.: US 2008/0191977 A1
(43) Pub. Date: Aug. 14, 2008

(54) Method and apparatus for digitally driving an AMOLED

(75) Inventors: Yong-Yun Park, Daejeon (KR); Jong Seon Kim, Seongnam-si (KR); Jong Hak Baek, Seoul (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 12/001,542

(22) Filed: Dec. 12, 2007

(30) Foreign Application Priority Data
Feb. 12, 2007 (KR) 10-2007-0014324

(51) Int. Cl. G09G 3/32

(52) U.S. Cl. 345/82

(57) ABSTRACT

In a method for digitally driving an AMOLED to display a plurality of different areas of the AMOLED including a first area displaying a first image and a second area displaying a second image, the method comprises: commencing display of at least one of a plurality of lines of the AMOLED to cause display of the first image beginning at a first area light emission start time of a sub-field period of the AMOLED frame period; and commencing display of at least one of a plurality of lines of the AMOLED to cause display of the second image beginning at a second area light emission start time of the sub-field period of the AMOLED frame period. In an apparatus for digitally driving an AMOLED, the apparatus comprises: an AMOLED panel; a memory storing graphic data that is displayed on the AMOLED panel; a source driver receiving the graphic data output from the memory and displaying the AMOLED panel; a gate driver addressing lines of the AMOLED panel; and a controller, wherein the controller controls at least one of a plurality of lines to commence display of a first image beginning at a first area light emission start time of a sub-field period of the AMOLED and controls at least one of a plurality of lines to commence display of a second image beginning at a second area light emission start time of the sub-field period of the AMOLED.

### CROSS-REFERENCE TO RELATED PATENT APPLICATIONS

This application claims the benefit of Korean Patent Application No. 10-2007-0014324, filed on Feb. 12, 2007, in the Korean Intellectual Property Office, the disclosure of which is incorporated herein in its entirety by reference.

### BACKGROUND OF THE INVENTION

1. Field of the Invention

The present invention relates to a driving apparatus using an active matrix organic light emitting diode (AMOLED), and more particularly, to a method and apparatus for driving an AMOLED to display a partial image of a time-division display feature of the AMOLED.

2. Description of the Related Art

Methods of displaying the gradation of an AMOLED include a voltage driving method and a digital driving method. The voltage driving method displays the gradation of a corresponding pixel in accordance with the magnitude of a voltage applied to each of a plurality of pixels. The digital driving method displays the gradation by varying the light emitting time of a corresponding pixel in accordance with digital data input to each pixel.

The voltage driving method has a problem in that the display of a gradation is difficult because the field effect transistors (FET) that are used to supply current, as well as the individual AMOLEDs that emit light have a very wide voltage-to-brightness characteristic dispersion. Thus, the digital driving method, that is, a time-division driving method, is commonly used as a method that is capable of uniformly displaying an image, while being less affected by the characteristic dispersion of the AMOLED.

Time-division driving methods include a display-period-separated (DPS) driving method and a simultaneous-erasing-scan (SES) method. The DPS driving method and the SES method are well-described in SID 00 DIGEST, p 924, 36.4 L: Late-News Paper: 4.0-in. TFT-OLED Displays and a Novel Digital Driving Method, the contents being incorporated herein by reference.

The DPS method is limited in that the driving frequency cannot be increased due to the limit in the operation speed of a switching TFT and since the time for emitting and displaying light is relatively decreased because the time for scanning data extends so that brightness is difficult to control and improve.

Accordingly, the SES method has been used to address these problems. In the SES case, the timing for writing and erasing data must be accurately determined when the data is scanned. Thus, the SES method is convenient for displaying a single type of data on the entire surface of a panel. However, it is difficult under the SES method to display data in plural areas of a panel, i.e. a window area or a partial area of the panel.

### SUMMARY OF THE INVENTION

To address the above and/or other limitations, embodiments of the present disclosure provide a method and apparatus which can simultaneously display different types of areas, such as a window area or a partial area, on an AMOLED panel, while using an SES driving method.

In one aspect, a method for digitally driving an AMOLED to display a plurality of different areas of the AMOLED including a first area displaying a first image and a second area displaying a second image comprises: commencing display of at least one of a plurality of lines of the AMOLED to cause display of the first image beginning at a first area light emission start time of a sub-field period of the AMOLED frame period; and commencing display of at least one of a plurality of lines of the AMOLED to cause display of the second image beginning at a second area light emission start time of the sub-field period of the AMOLED frame period.

In one embodiment, the method for digitally driving comprises an SES (simultaneous-erasing-scan) driving method.

In another embodiment, the first area and the second area are respectively a background area and a window area of the AMOLED.

In another embodiment, the first area and the second area are respectively a background area and a partial area of the AMOLED.

In another embodiment, the first area light emission start time and the second area light emission start time are respectively a first time and a middle time of the sub-field period.

In another embodiment, in the displaying of any one of lines to display the first image, each of pixels included in the lines to display the first image emits light for a time weight that is determined according to a data bit input to each of the pixels.

In another embodiment, in the displaying of any one of lines to display the second image, each of pixels included in the lines to display the second image emits light for the time weight.

In another aspect, an apparatus for digitally driving an AMOLED, the apparatus comprises: an AMOLED panel; a memory storing graphic data that is displayed on the AMOLED panel; a source driver receiving the graphic data output from the memory and displaying the AMOLED panel; a gate driver addressing lines of the AMOLED panel; and a controller, wherein the controller controls at least one of a plurality of lines to commence display of a first image beginning at a first area light emission start time of a sub-field period of the AMOLED and controls at least one of a plurality of lines to commence display of a second image beginning at a second area light emission start time of the sub-field period of the AMOLED.

In one embodiment, the controller controls the lines to display the first image and the second image using an SES (simultaneous-erasing-scan) method.

In another embodiment, the first area and the second area are respectively a background area and a window area of the AMOLED.

In another embodiment, the first area and the second area are respectively a background area and a partial area of the AMOLED.

In another embodiment, the first area light emission start time and the second area light emission start time are respectively a first time and a middle time of the sub-field.

In another embodiment, the controller controls each of pixels included in any one of the at least one of the lines to display the first image to emit light for a time weight that is determined according to a data bit input to each of the pixels.

In another embodiment, the controller controls each of pixels included in any one of the at least one of the lines to display the second image to emit light for the time weight.

### BRIEF DESCRIPTION OF THE DRAWINGS

The above and other features and advantages of the embodiments of the present specification will become more apparent by describing in detail preferred embodiments thereof with reference to the attached drawings in which:

FIG. 1 is a graph for explaining an SES driving method;

FIG. 2 illustrates the time weights used in the SES driving method according to an embodiment of the present invention;

FIG. 3 is a graph for explaining a method for driving an AMOLED method according to an embodiment of the present invention;

FIG. 4 is a graph for explaining the AMOLED according to an embodiment of the present invention;

FIG. 5 is a functional block diagram of an apparatus for driving an AMOLED according to an embodiment of the present invention; and

FIG. 6 is a graph for explaining the operation of the SES driving method for a window area and a partial area of an AMOLED according to an embodiment of the present invention.

### DETAILED DESCRIPTION OF EMBODIMENTS OF THE INVENTION

Embodiments of the present invention will now be described more fully hereinafter with reference to the accompanying drawings, in which preferred embodiments of the invention are shown. The invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected”, “coupled”, or “adjacent” to another element, it can be directly connected or coupled to the other element or intervening elements may be present. In contrast, when an element is referred to as being “directly connected”, “directly coupled”, or “directly adjacent” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

When a constituent element is said to “transmit” data to another constituent element, the data is transmitted to the other constituent element directly or through at least one of other constituent elements. Conversely, when a constituent element is said to “directly transmit” data to another constituent element, the data can be transmitted directly to the other constituent element without passing through other constituent elements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

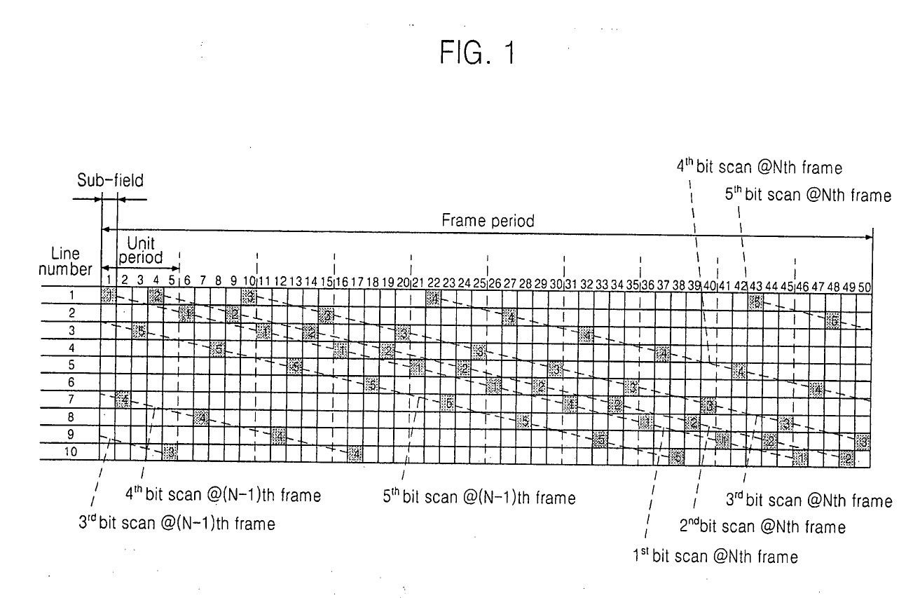

FIG. 1 is a graph for explaining an SES driving method. Referring to FIG. 1, the time for displaying a frame using the SES method is referred to a frame period and the time from a time when any line begins light emission to a time when the next line begins light emission is defined to be a unit period.

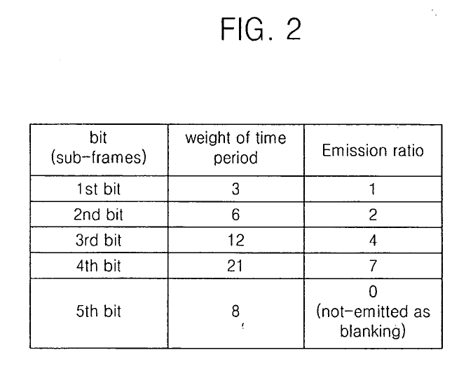

In FIG. 1, the SES method illustrated is based on a case in which each pixel receives five bits of data. The unit period includes five sub-field periods, and one sub-field period is a period of time that is used to display a gray level of each bit of the data. The SES method as shown in FIG. 1, uses a method of displaying digital data input to each pixel by setting different time weights to each bit of the digital data. An example time weighting approach is shown in FIG. 2.

FIG. 2 illustrates the time weights used in the SES method according to an example embodiment of the present invention. Referring to FIG. 2, it can be seen that the light emitting time increases from the first bit to the upper bits, i.e., to the most significant bit (MSB). Thus, a gradation corresponding to the digital data can be displayed by differently setting the light emitting time according to the digital data input to each pixel. Also, an emission ratio is shown in FIG. 2. The time weights shown in FIG. 2 are a mere example and the scope of the present invention is not limited thereto.

Referring to FIGS. 1 and 2, during a display driving operation, the light emission (display) of the first line begins from the start time of a frame period. An AMOLED driving apparatus (not shown) writes the first bit (LSB, least significant bit) of the digital data corresponding to each pixel included in the first line of the data stored in a memory (not shown) to a source driver (not shown) and lights the pixels for a first time weight “3” corresponding to the first bit (LSB) that is written. After emitting light for the first time weight “3”, the AMOLED driving apparatus writes the second bit of the digital, data corresponding to each pixel included in the first line of the data stored in the memory to the source driver and lights the pixels for a second time weight “6” corresponding to the second bit that is written.

In the same manner, the respective pixels can emit light for time weights “12” and “21” corresponding to the third and fourth bits. Also, in this example, the fifth bit may not emit light for the separation of frames.

In the meantime, the AMOLED driving apparatus begins the light emission of the second line using the same method as that used in the first line beginning at a time (sub-field 6) after the unit period passes from the start time (sub-field 1) of the frame period. That is, the AMOLED starts display of the next line after the unit period passes from the time when an arbitrary line begins to display.

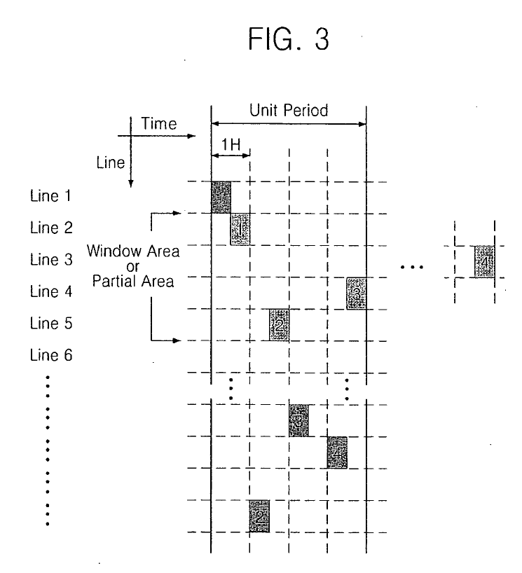

As described above, in the SES driving method, the lines are selected according to a predetermined time interval and the light emission time according to the data bit input to the selected lines is controlled in accordance with the time weight. However, in order to display at least two areas or regions having different types of images according to the SES driving method, when an image is input while another image is being displayed, there may be a so-called time collision between the two images. For example, when second digital data corresponding to the second image is input to each of a subset pixels while each of the pixels of the subset included in a line corresponding to the first image that is being displayed in advance emits light for a time corresponding to the second bit of first digital data corresponding to the first image, there may be a time collision because the same pixels of the subset may start light emission for a time corresponding to the first bit of the second digital data corresponding to the second image while the first data is still being imaged. In view of this limitation, the AMOLED driving method and apparatus according to the present invention are configured and arranged to display at least two areas or regions having different types of images. FIG. 3 is a graph for explaining a method for driving an AMOLED method according to an embodiment of the present invention. Referring to FIG. 3, an AMOLED driving method suitable for displaying two different areas is described. In this example, a unit period consists of four sub-field periods, where a sub-field period is defined to be 1H.

In the AMOLED driving method according to the present embodiment, two light emission start times are initiated during a single sub-field period, unlike the conventional SES approach. That is, according to the conventional SES approach, only one line of an AMOLED panel will begin to emit light based on bit data during a given, single, sub-field period. For example, as shown in FIG. 1, during sub-field 1 there is only one line (line number 1) that begins to emit light based on new bit data that is different from bit data corresponding to the previous period of sub-field 1. That is, during the period before the first sub-field period, when the presently displayed frame is the N^{th} frame, the first line (line number 1) emits light based on the fifth bit of the (N−1)^{th} frame. During the first sub-field period (1), the first line (line number 1) emits light based on a new bit, that is, the first bit of the N^{th} frame.

Also, during the second sub-field period, a line that starts light emission based on a bit different from that during the period before the second sub-field period, that is, the first sub-field period, is the seventh line (line number 7), and the seventh line (line number 7) is the only line at that time that begins to emit light based on new data. That is, during the period before the second sub-field period, the seventh line emits light based on the third bit of the (N−1)^{th} frame. During the second sub-field period (2), the seventh line (line number 7) emits light based on a new data bit, that is, the fourth bit of the (N−1)^{th} frame.

According to the conventional SES driving method, only a single new line is selected during an entire single sub-field period, and the data bit causing the selected line to emit light is changed. In view of this, the conventional SES method is not suitable for simultaneously displaying different types of images on an AMOLED.

Thus, as shown in FIG. 3, in the AMOLED driving method and apparatus according to the present embodiment, two lines are caused to emit light based on a new data bit during the same, single, sub-field period. Any one of the selected two lines can be a line, for example, line 1, included in a first area or region, for example, a background area, and a line, for example, line 2, included in a second area or region, for example, a window area or a partial area. That is, a line included in the first area, for example, a background area, can begin light emission commencing at the start time of the single sub-field period. Also, a line included in the second area can begin light emission commencing at a predetermined different time of the same, single sub-field period.

According to the AMOLED driving method according to the present embodiment, since the time for displaying the second area, for example, a window area or a partial area, is separately controlled, different types of images can be simultaneously displayed.

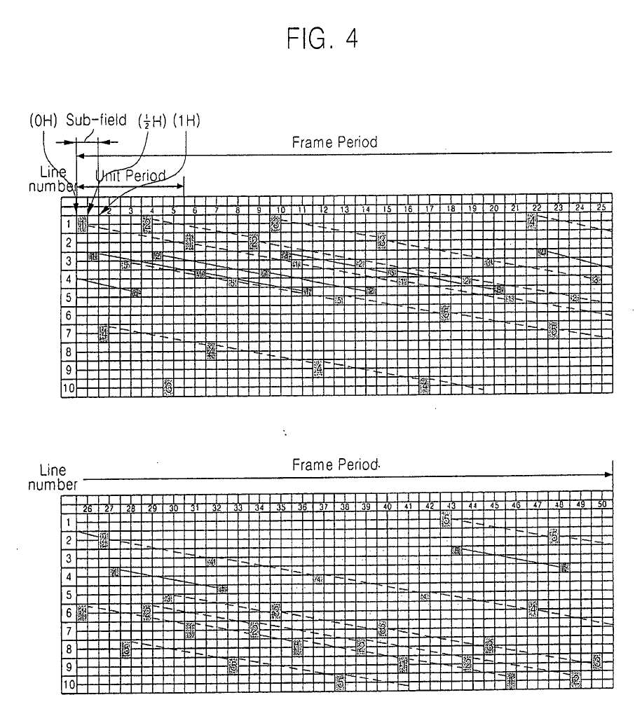

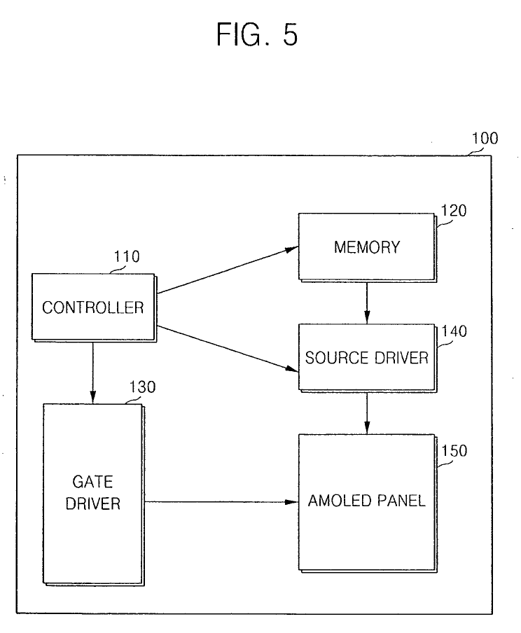

FIG. 4 is a graph that illustrates the operation of an AMOLED driving method and apparatus according to an embodiment of the present invention. FIG. 5 is a functional block diagram of an apparatus for driving an AMOLED according to an embodiment of the present invention. Referring to FIGS. 4 and 5, an AMOLED driving apparatus 100 according to the present embodiment includes a controller 110, a memory 120, a gate driver 130, a source driver 140, and an AMOLED panel 150. In one embodiment, the memory 120 can be embodied by a graphic random access memory (GRAM), although other forms of memory are equally applicable to the embodiments of the present invention.

To display graphic data input from a host (not shown) to the memory 120 on the AMOLED panel 150, the controller 110 controls the memory 120 and the source driver 140 so that the graphic data stored in the memory 120 is written to the source driver 140. Also, the controller 110 addresses lines of the AMOLED panel 150 by controlling the gate driver 130. The controller 110 can include a timing generator (not shown) for performing the SES driving method.

In FIG. 4, a single unit period consists of five sub-field periods. First data of the first image and second data of the second image, the first and second data being different graphic data, are stored in the memory 120. The first image and the second image can be respectively displayed in the first area and the second area. In this example embodiment, the second area is a window area and is displayed on the third, fourth, and fifth lines of the display.

The controller 110 controls any one line, for example, the first line, of the various lines, for example, the first, second, sixth, seventh, eighth, ninth, and tenth lines, to display the first image beginning at the first area light emission start time of the sub-field period, for example, the first sub-field. For example, the controller 110 can display the first image according to the SES driving method by causing the lines corresponding to the first area, for example, a background area, of the AMOLED panel 150 to emit light from the start time, for example, the first time of the first sub-field, in a manner similar to the conventional SES driving method. In addition, according to the present embodiment of the invention, the controller 110 can additionally display the second image in the SES driving method by causing the lines corresponding to the second area, for example, a window area, of the AMOLED panel 150 to emit light beginning at predetermined time of the sub-field period, that is, the second area light emission start time of the first sub-field.

Thus, in the process of displaying the images according to the passage of time, under the control of the controller 110, the first line begins light emission at the first area light emission, in this case, start time “0H” of the first sub-field period. Then, the third line that is the first one of the lines included in the second area begins light emission from the second area light emission start time, in this case “½ H” of the first sub-field period.

The information related to the addresses of the lines included in the second area can be stored in a predetermined register (not shown) when the second image data is input from the host to the memory 120. In this case, the controller 110 recognizes in advance the addresses of the lines included in the second area based on the information stored in the register.

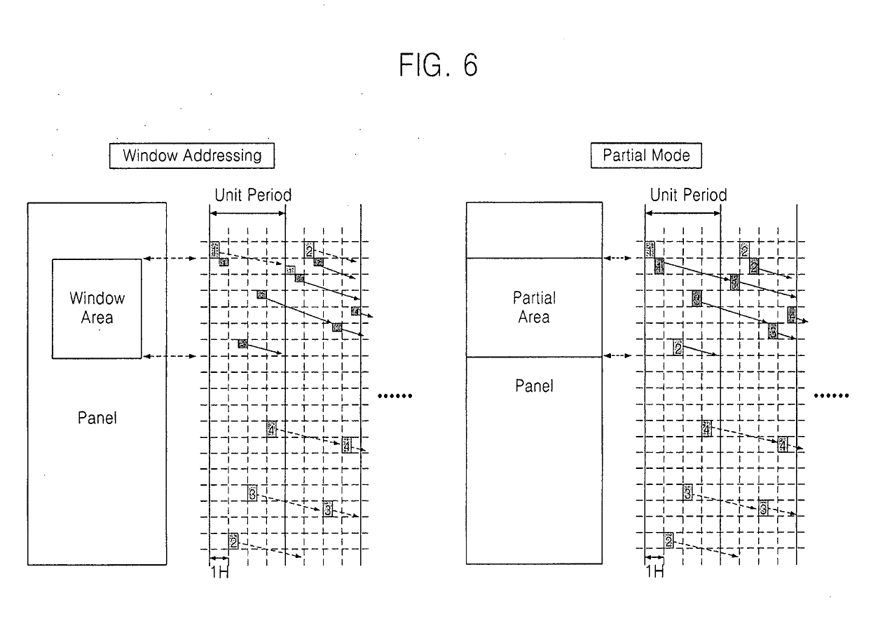

Also, as shown in FIG. 6, when the second area is a window area, the lines included in the second area include a set of pixels that are included in the first area and a set of pixels that are included in the second area. Thus, the pixels that begin light emission at the time of the second area light emission start time “½ H” are pixels included in the window area of the pixels included in the third line. The pixels included in the first area of the pixels included in the third line start light emission from the eleventh sub-field as in the conventional SES driving method as shown in FIG. 1.

As described above, in the AMOLED driving method according to the present embodiment, pixels corresponding to the first area and the second area begin light emission at different light emission start times during a single sub-field period. When the light emission begins, the lines included in the first area and the lines included in the second area can emit light independently in the conventional SES driving method. Also, since the controller 110 separately performs time control to display the first area and the second area, different types of data can be simultaneously displayed in accordance with the embodiments of the present invention.

With respect to the sub-field start period, the first area light emission start time and the second area light emission start time can be the first time “0H” and a middle time “½ H” of the sub-field period, for example, “1H”. However, the scope of the present invention is not limited thereto and it is sufficient that the first area light emission start time and the second area light emission start time are included at any suitable position in the sub-field period. Also, when there are more than two, for example, three, different types of graphic data being displayed, the first area light emission start time can be a different time included in the sub-field period, that is, other than “0 H”.

Although the graphic data corresponding to the second image is input to the source driver 140 through the memory 120 before the first sub-field period in the example of FIG. 4, the graphic data corresponding to the second image can be input while the first image is being displayed. For example, in FIG. 4, when the graphic data corresponding to the second image is input to the source driver 140 during the first sub-field period through the fifth sub-field period, the time to start the light emission of the pixels included in the second area of the third line can be the second area light emission start time, that is, (5+½)H, of the sixth sub-field.

The first area and the second area can be displayed in the SES driving method of the present invention based on the time weight, as shown and described above in connection with FIG. 2.

FIG. 6 is a graph for explaining the operation of the SES driving method for a window area and a partial area of an AMOLED according to an embodiment of the present invention. As shown in FIG. 6, when the second area is a window area, the lines including pixels included in the second area can include pixels included in the first area. In this case, the method described above with reference to FIG. 4 can be performed. In the meantime, as shown in FIG. 6, when the second area is a partial area, the lines included in the first area and the lines included in the second area can be independently displayed using the SES driving method by varying the light emission start time.

As described above, in the AMOLED driving method according to the present invention, different types of data such as a window area or a partial area can be efficiently displayed at the same time while using the SES driving method.

While embodiments of the invention have been particularly shown and described with reference to preferred embodiments thereof, it will be understood by those skilled in the art that various changes in form and details may be made therein without departing from the spirit and scope of the invention as defined by the appended claims.

What is claimed is:

1. A method for digitally driving an AMOLED to display a plurality of different areas of the AMOLED including a first area displaying a first image and a second area displaying a second image, the method comprising:
commencing display of at least one of a plurality of lines of the AMOLED to cause display of the first image beginning at a first area light emission start time of a sub-field period of the AMOLED frame period; and
commencing display of at least one of a plurality of lines of the AMOLED to cause display of the second image beginning at a second area light emission start time of the sub-field period of the AMOLED frame period.

2. The method of claim 1 wherein the method for digitally driving comprises an SES (simultaneous-erasing-scan) driving method.

3. The method of claim 1, wherein the first area and the second area are respectively a background area and a window area of the AMOLED.

4. The method of claim 1, wherein the first area and the second area are respectively a background area and a partial area of the AMOLED.

5. The method of claim 1, wherein the first area light emission start time and the second area light emission start time are respectively a first time and a middle time of the sub-field period.

6. The method of claim 1, wherein, in the displaying of any one of lines to display the first image, each of pixels included in the lines to display the first image emits light for a time weight that is determined according to a data bit input to each of the pixels.

7. The method of claim 6, wherein, in the displaying of any one of lines to display the second image, each of pixels included in the lines to display the second image emits light for the time weight.

8. An apparatus for digitally driving an AMOLED, the apparatus comprising:
an AMOLED panel;
a memory storing graphic data that is displayed on the AMOLED panel;
a source driver receiving the graphic data output from the memory and displaying the AMOLED panel;
a gate driver addressing lines of the AMOLED panel; and
a controller,
wherein the controller controls at least one of a plurality of lines to commence display of a first image beginning at a first area light emission start time of a sub-field period of the AMOLED and controls at least one of a plurality of lines to commence display of a second image beginning at a second area light emission start time of the sub-field period of the AMOLED.

9. The apparatus of claim 8, wherein the controller controls the lines to display the first image and the second image using an SES (simultaneous-erasing-scan) method.

10. The apparatus of claim 8, wherein the first area and the second area are respectively a background area and a window area of the AMOLED.

11. The apparatus of claim 8, wherein the first area and the second area are respectively a background area and a partial area of the AMOLED.

12. The apparatus of claim 8, wherein the first area light emission start time and the second area light emission start time are respectively a first time and a middle time of the sub-field.

13. The apparatus of claim 8, wherein the controller controls each of pixels included in any one of the at least one of the lines to display the first image to emit light for a time weight that is determined according to a data bit input to each of the pixels.

14. The apparatus of claim 13, wherein the controller controls each of pixels included in any one of the at least one of the lines to display the second image to emit light for the time weight.
